(19) United States
(12) Patent Application Publication
(10) Pub. No.: US 2016/0326771 A1
(43) Pub. Date: Nov. 10, 2016

(54) MUTE DOOR LOCK

(71) Applicant: GUANGDONG JUSEN HARDWARE PRECISION MANUFACTURING CO., LTD., Foshan, Guangdong (CN)

(72) Inventor: Zhi Qi, Foshan, Guangdong (CN)

(73) Assignee: GUANGDONG JUSEN HARDWARE PRECISION MANUFACTURING CO., LTD., Foshan, Guangdong (CN)

(21) Appl. No.: 15/109,136

(22) PCT Filed: Aug. 20, 2015
(86) PCT No.: PCT/CN2015/087570

§ 371 Date: Jun. 30, 2016

(30) Foreign Application Priority Data
Oct. 23, 2014 (CN) 201420615309.7

(51) Int. Cl. E05B 17/00; E05C 1/08; E05B 15/16

(52) U.S. Cl. CPC E05B 17/0045; E05B 17/0041; E05B 15/1635; E05C 1/08

(57) ABSTRACT

A mute door lock includes a lower seat plate, a lining plate and an oriented plate disposed on the lower seat plate, wherein a latch bolt is mounted on the oriented plate via a guide rod at the tail end of the latch bolt, the latch bolt is inserted into a bolt hole of the lining plate, a spring is sheathed onto the guide rod, which abuts between the oriented plate and the latch bolt and always pushes the latch bolt outward. A tail part of the guide rod is provided with a reset plate which abuts against a linkage mechanism supported by a buffer cylinder, the linkage mechanism drives the buffer cylinder to stretch. The buffer cylinder is connected to the latch bolt via the linkage mechanism, which can make the latch bolt restore slowly, avoiding the noise generated when the traditional latch bolt is restored quickly.

### BACKGROUND OF THE INVENTION

1. Field of the Invention

The present invention relates to a door lock, and more particularly refers to a novel mute door lock.

2. Description of Related Art

Currently, a variety of technical solutions have been applied in door locks used widely on the market to realize mute effect: CN203050243U discloses a low resistance mute door lock, wherein a soft roller is provided in front end of a lock box, a soft guide roller is provided in front end of a buckle box, and a soft box buckle shrapnel is deposited inside the buckle box. With this setting, noise issued from friction or impact among the latch, the lock box, and the buckle box could be reduce when the door is locked; CN202530854U discloses a mute door lock, wherein a washer is set at engaging place of a neck part of a locking tongue and a slider, this configuration is provided without relative motion and collision between the locking tongue and the slider, thus to avoid noise; CN202530855U discloses a mute door lock, wherein a recess is provided on surface of a latch, and a mute apron is attached in the recess. Thickness of the mute apron is bigger than depth of the recess, which makes surface of the apron higher than surface of other parts of the latch, friction or impact between the metal pieces can be avoided to the greatest extent, so noise caused from the door lock can be greatly reduced. From above patents, a certain effect against the noise issued from door closing can be achieved by reducing direct impact of the latch or improvement of the elements contacting with the latch, thus to reduce the noise when door is closed, these solutions all target at the latch which are most likely to produce impact. However, the above solutions realize return of the latch by spring rebound structure, and when door is closed, the latch should be ejected quickly because of resilient action of the spring, and it must make noise as it hit any hard parts, so the solutions cannot solve fundamentally the noise problem.

Regarding the issue above, the Chinese patent No. 201410150578.5 proposes a mute lock with a damper, main structure of which: the damper is mounted between an inclined latch and a lock body, wherein the damper is a stretch-type damping. The latch might retreat to compress the damper to make it return while unlocking. During the lock, the latch is pushed forward by the spring, at this time, the damper's buffer function that makes the latch slowly advance, until it returns in place. Thus, the problems that the latch returns quickly under the action of the spring during the lock and the lock body, as shown in the traditional art, hits with other pieces to make noise could be avoided. However, the lock process of the above structure is too slow. That is, the latch acts as a buffer while locking, which leads the latch cannot be insert into a keyhole set on the door frame. So users have to manually pull the door for a period of time and they could release it until the latch is inserted into the keyhole. They cannot lock the door by traditional way because it might not lock well. Therefore, it is necessary to improve the existing mute locks.

### SUMMARY OF THE INVENTION

On account of the lack of the prior art, an object of the present invention is to provide a novel mute and anti-theft lock which has a simple structure and low production cost and can facilitate assembly and production. The mute lock of the invention, not only can reduce noise, but also assure to lock quickly.

Object of the present invention is implemented in following way: a mute door lock, comprising a lower seat plate, a lining plate and an oriented plate disposed on the lower seat plate, wherein a latch bolt is mounted on the oriented plate via a guide rod at tail end of the latch bolt in such a way that it can slide forward and backward, the latch bolt is inserted into a bolt hole of the lining plate, a spring is sheathed onto the guide rod, which abuts between the oriented plate and the latch bolt and always pushes the latch bolt outward, it is characterized in that, a tail part of the guide rod is provided with a reset plate which abuts against a linkage mechanism supported by a buffer cylinder, the linkage mechanism driving the buffer cylinder to stretch when the latch bolt draws back to unlock, the buffer cylinder serves for cushion and restoration when the latch bolt moves forward to lock, such that the latch bolt can move forward slowly until the buffer cylinder is restored to an original point.

The linkage mechanism comprises a contact block set on top of a piston rob of the buffer cylinder, a triangular arm and a driving arm swingably hinged to the lower seat plate, wherein a rear end of the triangular arm is hinged on the contact block, a front end of which presses against a guiding block of the driving arm; a front end of the driving arm is hinged on the lower seat plate and its tail end is provided with a guide surface and contacts with a pushing block provided on the reset plate, the pushing block promotes the drive arm yaw to stretch the buffer cylinder when the latch bolt is retracted.

The guide surface set on the driving arm is obliquely disposed on the rear end thereof, and the guide surface and a slip surface of the driving arm are connected with arc transition.

The linkage mechanism comprises a release lever mounted on the lower seat plate, cross-section of the release lever has a “7” shape, and its middle portion is hinged on the lower seat plate, when a deflecting block disposed on its front end presses against the contact block on the top of the piston rob of the buffer cylinder, a guiding arm disposed on its trailing end presses against the return plate.

The reset plate extends rearward to form a guiding plate, the guiding arm of the release lever presses against the guiding plate, the guiding plate promotes the release lever yaw to stretch the buffer cylinder when the latch bolt is retracted.

The linkage mechanism comprises a deflecting piece with a trailing end being hinged on the lower seat plate, the deflecting piece is deposited with a guiding groove, a slider is mounted on the lower seat plate by two positioning columns and slidable back and forth therein, a connecting column is deposited on the slider and inserted into the guiding groove of the deflecting piece, a paddle is deposited on the slider and behind the contact block of the buffer cylinder; a guiding piece extends from the reset plate and is under the deflecting piece.

The locating posts are located in guide grooves deposited on the lower seat plate and slidable back and forth therein.

Advantages of the mute lock of the present invention comprise: 1) providing a simple structure with low cost and strong market competitiveness. 2) connecting the buffer cylinder to the latch bolt via the linkage mechanism, which leads the latch bolt to drive the buffer cylinder to return in place, thus to buffer the latch bolt during the lock and avoid the noise caused in the prior art. 3) the latch bolt can be operated at two speed and to slow down to buffer, simultaneously, it can return in place quickly to lock, thus to avoid the shortcomings such as slow lock caused by the traditional whole buffer technology and lock failure.

### BRIEF DESCRIPTION OF THE DRAWINGS

FIGS. 1 and 2 are return and locking state diagrams of the latch bolts of a first embodiment of the invention;

FIGS. 3 and 4 are semi-locking state diagrams of the latch bolts of the first embodiment of the invention;

FIGS. 5 and 6 are fully retracting and unlocking state diagrams of the latch bolts of the first embodiment of the invention;

FIG. 7 is a return and locking state diagram of the latch bolt of a second embodiment of the invention;

FIG. 8 is a semi-locking state diagram of the latch bolt of the second embodiment of the invention;

FIG. 9 is a fully retracting and unlocking state diagram of the latch bolt of the second embodiment of the invention;

FIG. 10 is a return and locking state diagram of the latch bolt of a third embodiment of the invention;

FIG. 11 is a semi-locking state diagram of the latch bolt of the third embodiment of the invention;

FIG. 12 is a fully retracting and unlocking state diagram of the latch bolt of the third embodiment of the invention;

### DESCRIPTION OF THE PREFERRED EMBODIMENTS

Structure of mute door lock of the present invention will be further explained with reference of the drawings. The mute door lock comprises a lower seat plate 1, a lining plate 2 and an oriented plate 3 disposed on the lower seat plate 1, a latch bolt 4 is mounted on the oriented plate 3 via a guide rod 5 at the tail end of the latch bolt 4 in such a way that it can slide forward and backward, the latch bolt 4 is inserted into a bolt hole 21 of the lining plate 2, a spring 53 is sheathed onto the guide rod 5, which abuts between the oriented plate 4 and the latch bolt 4 and always pushes the latch bolt 4 outward. A tail part of the guide rod 5 is provided with a reset plate 51 which abuts against a linkage mechanism supported by a buffer cylinder 6, the linkage mechanism might drive the buffer cylinder 6 to stretch when the latch bolt 4 draws back to unlock, the buffer cylinder serves for cushion and restoration when the latch bolt 4 moves forward to lock, such that the latch bolt 4 could move forward slowly until the buffer cylinder 6 is restored to an original point.

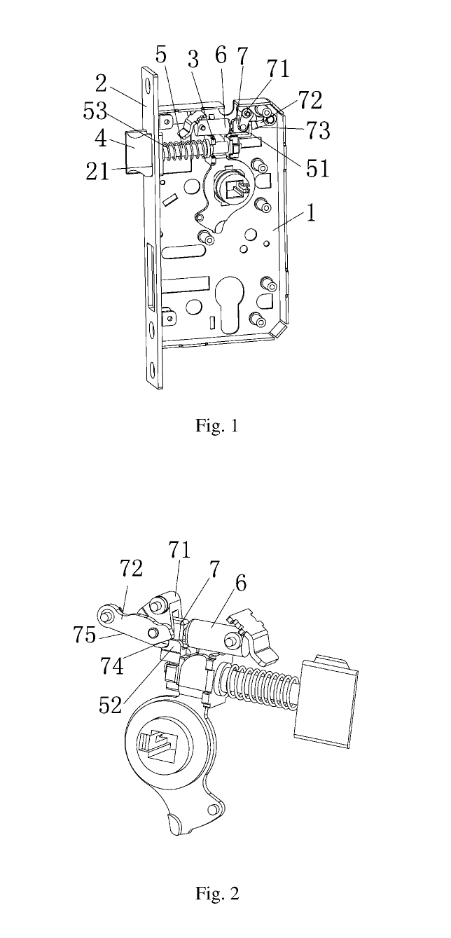

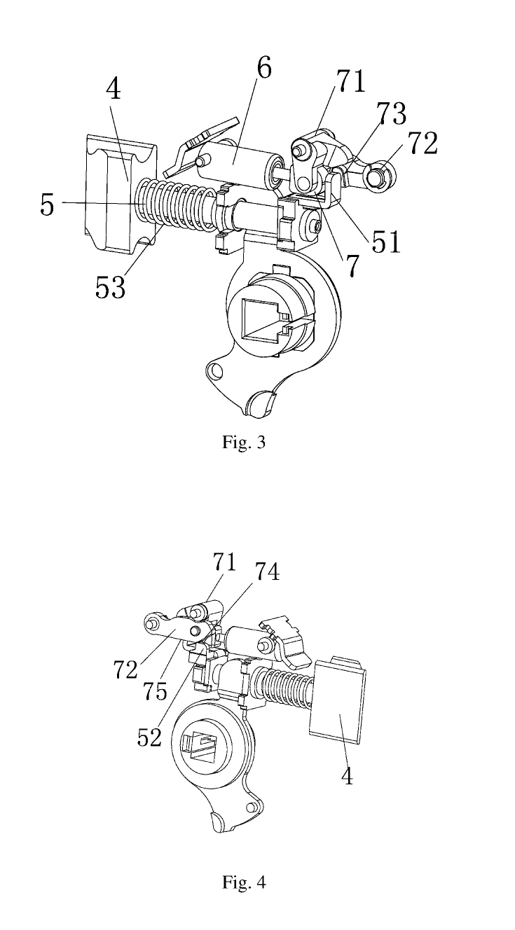

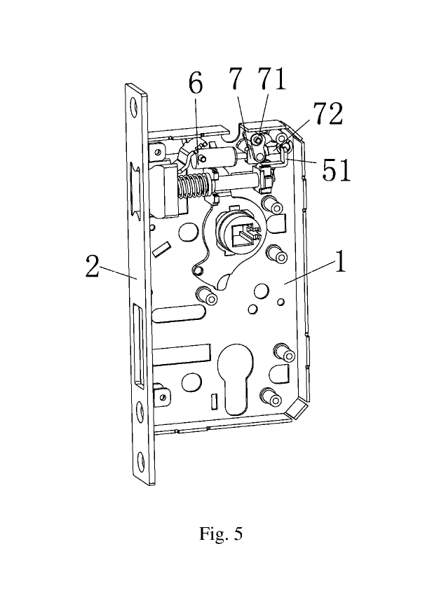

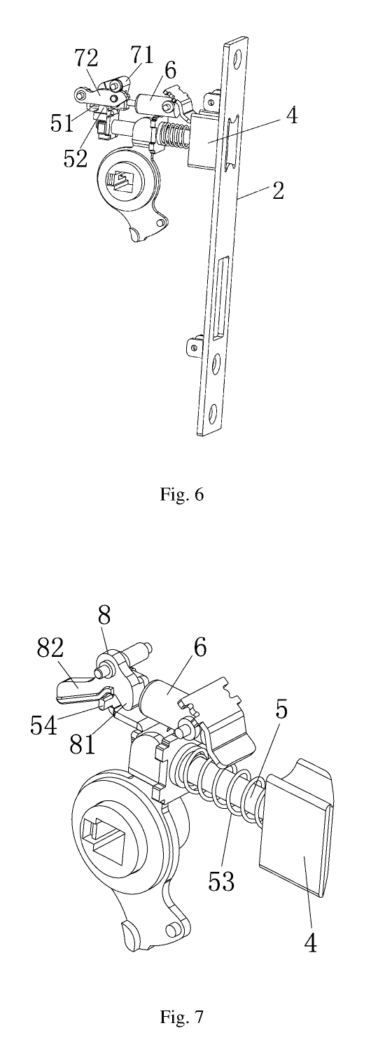

Referring to FIGS. 1-6, the linkage mechanism comprises a contact block 7 set on top of a piston rob of the buffer cylinder 6, a triangular arm 71 and a driving arm 72 swingably hinged to the lower seat plate 1, wherein a rear end of the triangular arm 71 is hinged on the contact block 7, a front end of which presses against a guiding block 73 of the driving arm 72; a front end of the driving arm 72 is hinged on the lower seat plate 1 and its tail end is provided with a guide surface 74 contacting with a pushing block 52 provided on the reset plate 51, the pushing block 52 could promote the drive arm 72 yaw to stretch the buffer cylinder 6 when the latch bolt 4 is retracted.

The guide surface 74 set on the driving arm 72 is obliquely disposed on the rear end thereof, and the guide surface and a slip surface 75 of the driving arm 72 are connected with arc transition.

Course of operation of the embodiment comprises: the latch bolt under normal state extends outwards by the spring 53 and inserts into a keyhole of a door frame to lock. During the operation of unlocking the door by an user, a lock rudder pushes rearward the guiding arm to make the latch bolt retreat. In this process, the spring 53 is compressed to drive the latch bolt return. At the same time, the pushing block 52 of the reset plate 51 moves backward to push the driving arm 72 which contacts with it to deflect upward, the triangular arm oscillates via the guiding block 73 of the driving arm 72, by this way, the piston rob of the buffer cylinder could be pulled out according to the principle of leverage and prepare for return. Which should be noted that: the guide surface 74 and the slip surface 75 deposited on the driving arm 72 could contact with the pushing block. When the pushing block moves until the end of the guide surface, the piston rod would be completely unplugged, but the pushing block might continue to move forward by action of the guiding lever until the latch bolt is fully retracted, so as to unlock the door.

During the lock, the latch bolt would lost support and quickly move outwardly under the action of the spring, until the reset plate 51 of the guiding lever contacts with the contact block 7 set on top of a piston rob. Since the contact block is made of plastic material and inside the lock, so any impact noise won't be produced even if both pieces quickly impact. At this time, the latch bolt has already been inserted into the keyhole to achieve the quick lock. Shortcoming of the traditional locks such as the slow lock caused by buffer during the whole process could be avoided. After the contact between the reset plate and the contact block 71, the piston rob is pushed by spring to return in place. The reset and damping effect of the buffer cylinder permits the latch bolt move slowly until full return and lock, thus to avoid the impact noise caused by the latch bolt's quick return as traditional art.

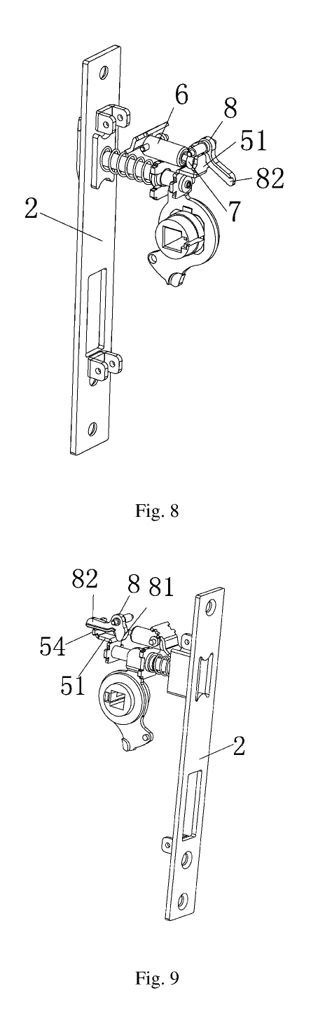

The second embodiment: referring to FIGS. 7-9, the linkage mechanism comprises a release lever 8 swingably hinged on the lower seat plate 1, cross-section of the release lever 8 has a “7” shape, and its middle portion is hinged on the lower seat plate 1, when a deflecting block 81 disposed on its front end presses against the contact block 7 on the top of the piston rob of the buffer cylinder 6, a guiding arm 82 disposed on its trailing end presses against the reset plate 51.

The reset plate 51 extends rearward to form a guiding plate 54, the guiding arm 82 of the release lever 8 presses against the guiding plate 54, the guiding plate 54 promotes the release lever 8 yaw to stretch the buffer cylinder 6 when the latch bolt 4 is retracted.

Course of operation of the embodiment comprises: during unlock process, the lock rudder strikes the guiding arm and the reset plate 51 to push them backward, the guiding plate 54 of the reset plate extends backward pushes the release lever 8 to deflect. According to the principle of leverage, the lever is extended and buffered to prepare the return of the latch bolt. When the release lever deflect to a certain angle, the guiding arm set on tail part of the release lever tends to parallel, that makes the buffer cylinder be fully stretched, after that, the guiding arm could continue to retreat until the latch bolt is fully retracted, thus to unlock.

During the lock, according to the same principle, the latch bolt is rebounded at some distance via the spring to be locked, then the spring pushes the buffer cylinder to return in place, by this way, the damping effect could be provided thereon.

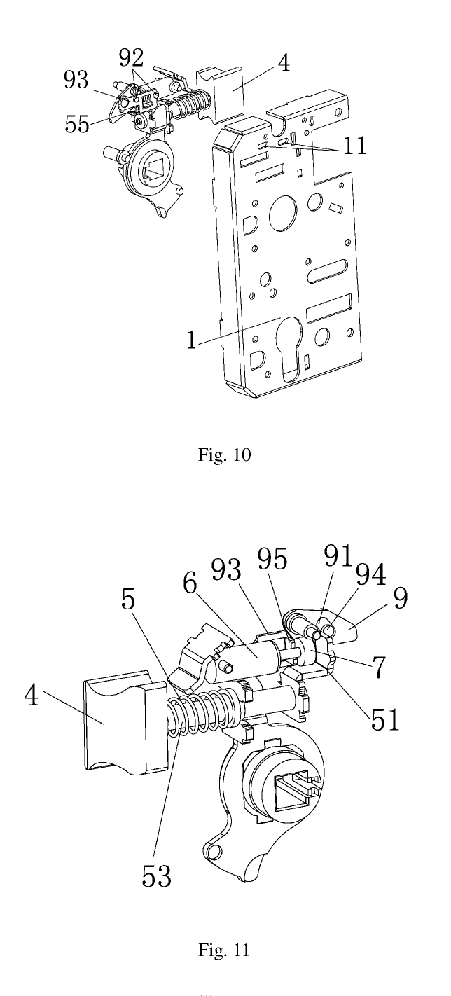

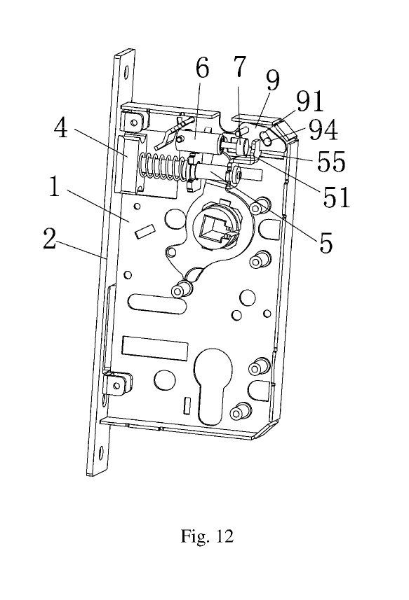

The third embodiment: referring to FIGS. 10-11, the linkage mechanism comprises a deflecting piece 9 with a trailing end being hinged on the lower seat plate 1, the deflecting piece 9 is deposited with a guiding groove 91, a slider 93 is mounted on the lower seat plate 1 by two positioning columns 92 and slidable back and forth therein, a connecting column 94 is deposited on the slider 93 and inserted into the guiding groove 91 of the deflecting piece 9, a paddle 95 is deposited on the slider 93 and behind the contact block 7 of the buffer cylinder 6; a guiding piece 55 extends from the reset plate 51 and is under the deflecting piece 9.

The positioning columns 92 are placed in the guide grooves 11 of the lower seat plate 1 and can slide back and forth. Course of operation of the embodiment comprises: during unlock process, the lock rudder strikes the guiding arm and the reset plate 51 to push them backward, the guiding plate 55 extending backward from the reset plate pushes the end of the deflecting piece 9 to deflect upward, then the slider 93 begins to move backward via the guide groove, and the paddle 95 set on the slider is then driven to pull the piston to extend outward to prepare the return of the latch bolt. When the deflecting piece 9 deflects to a certain angle and is parallel to the guide surface area contacting with the paddle, that makes the buffer cylinder be fully stretched, after that, the guiding arm could continue to retreat until the latch bolt is fully retracted, thus to unlock.

During the lock, according to the same principle, the latch bolt is rebounded at some distance via the spring to be locked, then the reset plate 51 begins to contact with the contact block 7 of the buffer cylinder, and the spring pushes the buffer cylinder to return in place, by this way, the damping effect could be provided thereon.

Compared with the conventional art, the linkage mechanism of the present invention is deposited between the contact block and the reset plate and could stretch the buffer cylinder during the unlocking executed by the latch bolt, thus to prepare for the return of the latch bolt. When the latch bolt is fully retracted, a space could be formed between the reset plate and the contact block of the buffer cylinder to permit the latch bolt to return at two speed. The first one is high speed, so the latch bolt might be inserted into the keyhole quickly, while at the second speed, the buffer cylinder could damp the latch bolt to make it go forward slowly until it is completely locked. By this way, the latch bolt can be buffered to return in place to avoid operating noise, simultaneously, the latch bolt can be rebounded quickly to lock, thus to avoid the slow lock caused by the traditional whole buffer technology, that is complex to operate and easily leads to lock failure, etc. Therefore, the present invention can be applied in various lock to achieve the perfect quiet operation and ensure that people's normal life is not affected.

What is claimed is:

1. A mute door lock, comprising a lower seat plate (1), a lining plate (2) and an oriented plate (3) disposed on the lower seat plate, wherein a latch bolt (4) being mounted on the oriented plate (3) via a guide rod (5) at the tail end of the latch bolt in such a way that it can slide forward and backward, the latch bolt (4) being inserted into a bolt hole (21) of the lining plate, a spring (53) being sheathed onto the guide rod (5), which abuts between the oriented plate (3) and the latch bolt (4) and always pushes the latch bolt (4) outward, it is characterized in that, a tail part of the guide rod (5) being provided with a reset plate (51) which abuts against a linkage mechanism supported by a buffer cylinder (6), the linkage mechanism driving the buffer cylinder (6) to stretch when the latch bolt draws back to unlock, the buffer cylinder (6) serving for cushion and restoration when the latch bolt (4) moves forward to lock, such that the latch bolt (4) moving forward slowly until the buffer cylinder (6) is restored to an original point.

2. The mute door lock according to the claim 1, characterized in that the linkage mechanism comprises a contact block (7) set on top of a piston rob of the buffer cylinder (6), a triangular arm (71) and a driving arm (72) swingably hinged to the lower seat plate (1), wherein a rear end of the triangular arm (71) is hinged on the contact block (7), a front end of which presses against a guiding block (73) of the driving arm (72); a front end of the driving arm (72) is hinged on the lower seat plate (1), and its tail end is provided with a guide surface (74) and contacts with a pushing block (52) provided on the reset plate (51), the pushing block (52) promotes the drive arm (72) yaw to stretch the buffer cylinder (6) when the latch bolt (4) is retracted.

3. The mute door lock according to the claim 2, characterized in that the guide surface (74) set on the driving arm (72) is obliquely disposed on the rear end thereof, and the guide surface and a slip surface (75) of the driving arm (71) are connected with arc transition.

4. The mute door lock according to the claim 1, characterized in that the linkage mechanism comprises a release lever (8) mounted on the lower seat plate (1), cross-section of the release lever (8) has a “7” shape, and its middle portion is hinged on the lower seat plate (1), when a deflecting block (81) disposed on its front end presses against the contact block (7) on the top of the piston rob of the buffer cylinder (6), a guiding arm (82) disposed on its trailing end presses against the reset plate(51).

5. The mute door lock according to the claim 4, characterized in that the reset plate (51) extends rearward to form a guiding plate (54), the guiding arm (82) of the release lever (8) presses against the guiding plate (54), the guiding plate (54) promotes the release lever (8) yaw to stretch the buffer cylinder (6) when the latch bolt (4) is retracted.

6. The mute door lock according to the claim 1, characterized in that the linkage mechanism comprises a deflecting piece (9) with a trailing end being hinged on the lower seat plate (1), the deflecting piece (9) is deposited with a guiding groove (91), a slider (93) is mounted on the lower seat plate (1) by two positioning columns (92) and slidable back and forth therein, a connecting column (94) is deposited on the slider (93) and inserted into the guiding groove (91) of the deflecting piece (9), a paddle (95) is deposited on the slider (93) and behind the contact block (7) of the buffer cylinder (6); a guiding piece (55) extends from the reset plate (51) and is under the deflecting piece (9).

7. The mute door lock according to the claim 1, characterized in that the locating posts (92) are located in guide grooves (11) deposited on the lower seat plate (1) and slidable back and forth therein.
